(19) United States
(12) Patent Application Publication
(10) Pub. No.: US 2026/0076354 A1
(43) Pub. Date: Mar. 19, 2026

(54) INSECT BAIT STATION WITH THROUGH-FLOOR ACCESS OPENINGS

(71) Applicant: VMIP, LLC, Bedford, TX (US)

(72) Inventors: Ethan VICKERY, Colleyville, TX (US); Jay RASMUSSEN, Colleyville, TX (US)

(21) Appl. No.: 19/326,379

(22) Filed: Sep. 11, 2025

Related U.S. Application Data
(60) Provisional application No. 63/694,537, filed on Sep. 13, 2024.

(51) Int. Cl. A01M 1/20

(52) U.S. Cl. CPC A01M 1/2011

(57) ABSTRACT

A pest management apparatus comprising a base, a lid coupled to the base such that the lid and the base cooperate to form a chamber, and an inner tray disposed within the chamber, wherein at least a portion of the base is nested within at least a portion of the inner tray. The base comprises a floor defining openings aligned with openings of the inner tray such that pests can access the chamber through the openings of the base and the openings of the inner tray.

### CROSS-REFERENCE TO RELATED APPLICATIONS

This application claims the benefit of priority of U.S. Provisional Patent Application No. 63/694,537, filed Sep. 13, 2024, which is hereby incorporated by reference in its entirety.

### FIELD OF INVENTION

The present invention relates generally to pest management and more particularly, but not by way of limitation, to pest management apparatuses, assemblies and/or components.

### BACKGROUND

Various insect traps and bait stations have been known. However, many are overly complex and/or limited in terms of the types of insects for which they are effective.

### SUMMARY

Embodiments of the disclosed pest management apparatuses include a base and a lid coupled to the base. The base has a floor that defines one or more openings, each opening extending through the floor. These openings serve as entry points for pests. Together, the base and the lid form a chamber when the lid is in a closed position. In some such embodiments, the present apparatuses also include an inner tray having one or more openings. This inner tray is configured to be disposed within the chamber, with at least one of the opening(s) of the inner tray at least partially aligned with at least one of the opening(s) of the floor such that the chamber is accessible by an insect through the respective aligned openings of the floor and the inner tray.

In some embodiments, at least a portion of the base is nested within at least a portion of the inner tray.

In some embodiments, the lid is movable relative to the base, transitioning between open and closed positions, facilitating access to the chamber for maintenance or inspection. The base comprises a sidewall that defines an external perimeter of the base.

In some embodiments, the sidewall of the base includes one or more openings. These openings can serve as entry points for pests.

Further, in some embodiments, the floor of the base includes one or more protrusions, each extending into the chamber with each protrusion having a passageway in communication with the one of the one or more openings of the floor and the chamber, such that pests may enter the chamber through the opening(s) of the floor and the opening(s) of the inner tray.

In some embodiments, the inner tray comprises a first recessed portion and a ramp that extends outwardly, such that the ramp surrounds the first recessed portion, and the external perimeter of the ramp is larger at a lower portion of the inner tray than at an upper portion of the inner tray. This first recess can contain a bait to lure and trap pests.

Additionally, in some embodiments, the lower portion of the inner tray comprises a second recessed portion.

In some embodiments, the first recessed portion of the inner tray is divided into two or more compartments.

In some embodiments, the first recessed portion of the inner tray comprises one or more protrusions. In some such embodiments, the one or more protrusions of the first recessed portion of the inner tray correspond to the second recessed portion of the inner tray.

Additionally, in some embodiments, the floor of the base comprises an (e.g., circular) opening that aligns with the second recess of the inner tray.

In some embodiments, the protrusions of the base are each configured to extend into one of the opening(s) in the recessed portion of the inner tray.

In some embodiments, at least a portion of each protrusion of the base fits within a protrusion of the inner tray such that at least a portion of the base is nested within a portion of the inner tray; wherein the inner tray can be coupled to the base through a friction fit between the one or more protrusions of the inner tray and the one or more protrusions of the base.

In some embodiments, the inner surface of the lid includes protrusions that fit within the first recessed portion of the inner tray when closed.

In some embodiments, an anchoring base is attached to the base. The anchoring base provides additional stability and weight to the apparatus, which can be advantageous in outdoor environments or in situations with larger pests. The anchoring base includes one or more openings at least partially aligned with at least one of the opening(s) of the floor and at least one of the openings of the inner tray; such that the chamber is accessible by an insect through the respective openings of the anchoring base, the floor, and the inner tray.

The anchoring base may be secured to the base using a fastener that connects to an attachment piece.

The lid may further comprise openings and tooth projections that interact with corresponding features on the base. When the lid is in the closed position, these corresponding features interlock (with the projections of the lid or base contacting with the openings of the base or lid, respectively) to prevent the lid and base from being separated when pulled in opposite directions.

Embodiments of the present apparatuses may include a stake coupled to the base, which, when inserted into the ground/earth/comparable material can help to keep the apparatus remains securely positioned in its intended location.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale, unless otherwise noted, meaning that in each of the figures the sizes of the elements are accurate relative to each other at least for the depicted embodiments.

FIG. 1 is a perspective view of a first embodiment of one of the present pest management apparatuses in the closed position.

FIG. 2 is a perspective view of the apparatus of FIG. 1 in the open position.

FIG. 3 is a top view of the apparatus of FIG. 1.

FIGS. 4-7 are left, right, front and back views, respectively, of the apparatus of FIG. 1.

FIG. 8 is a top view of the apparatus of FIG. 1 in the open position.

FIG. 9A is a top perspective view of the base of the apparatus of FIG. 1.

FIG. 9B is a bottom perspective view of the base of the apparatus of FIG. 1.

FIG. 10A is a bottom perspective view of the inner tray of the apparatus of FIG. 1.

FIG. 10B is a top perspective view of the inner tray of FIG. 1.

FIG. 11 is a perspective view of a second embodiment of the present pest management apparatuses in the closed position, the second embodiment differing from the first embodiment only with respect to the configuration of the locking mechanism of the lid and the base.

FIG. 12 is a perspective view of the apparatus of FIG. 11 in the open position.

FIG. 13A is a perspective view of a third embodiment of the present pest management apparatuses in the open position.

FIG. 13B is a perspective view of the third embodiment in the closed position.

FIG. 14 is a top view of the apparatus of FIG. 13B with the lid in the closed position.

FIGS. 15-18 are left, right, front and back views, respectively, of the apparatus of FIG. 13B with the lid in the closed position.

FIG. 19 is a bottom view of the apparatus of FIG. 13A with the lid in the open position.

### DETAILED DESCRIPTION OF ILLUSTRATIVE EMBODIMENTS

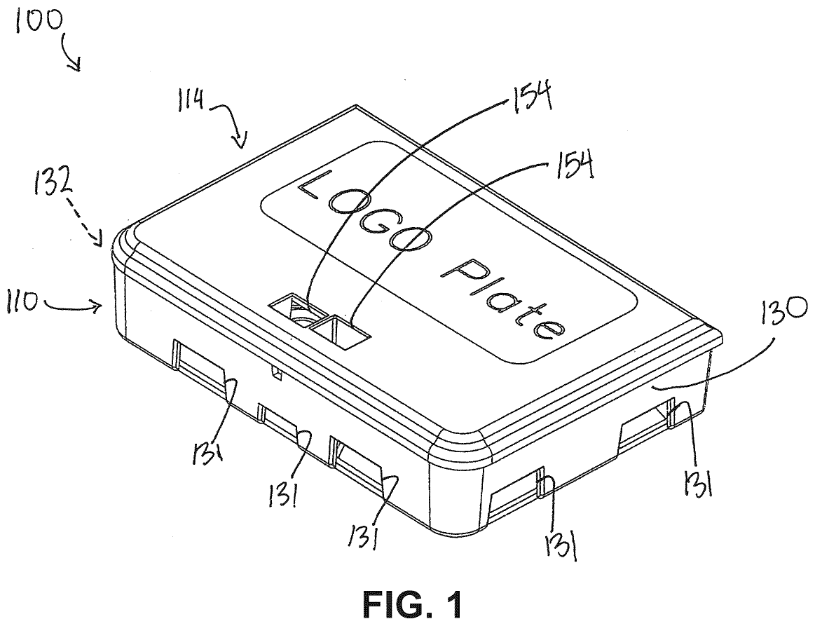

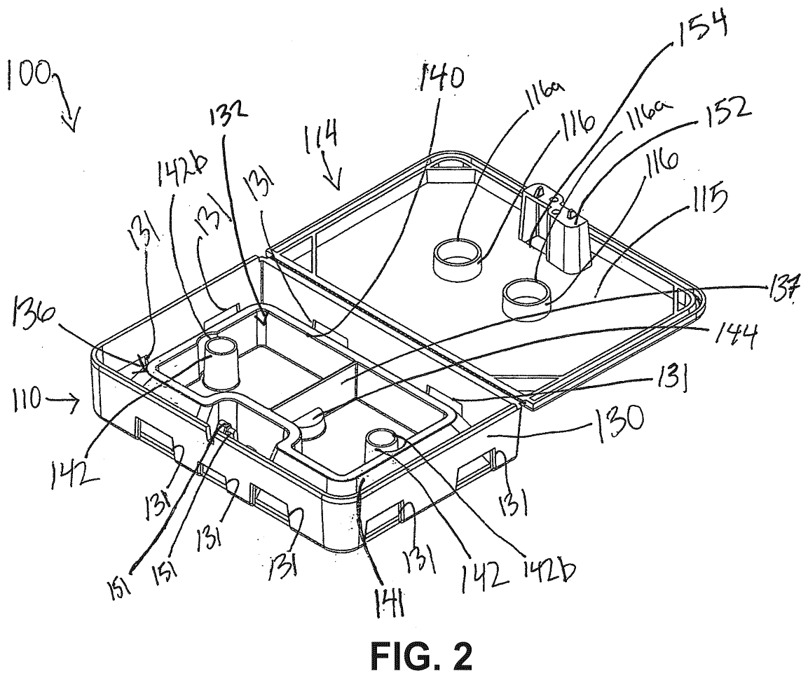

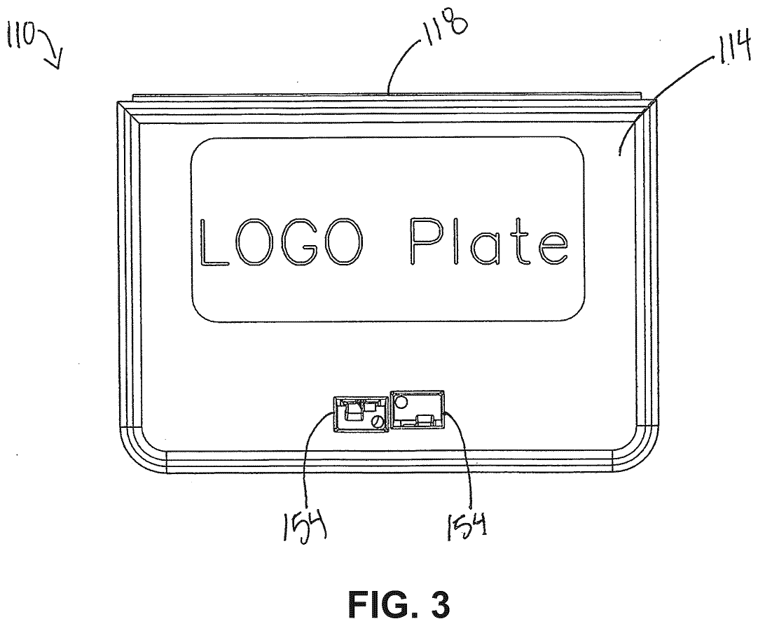

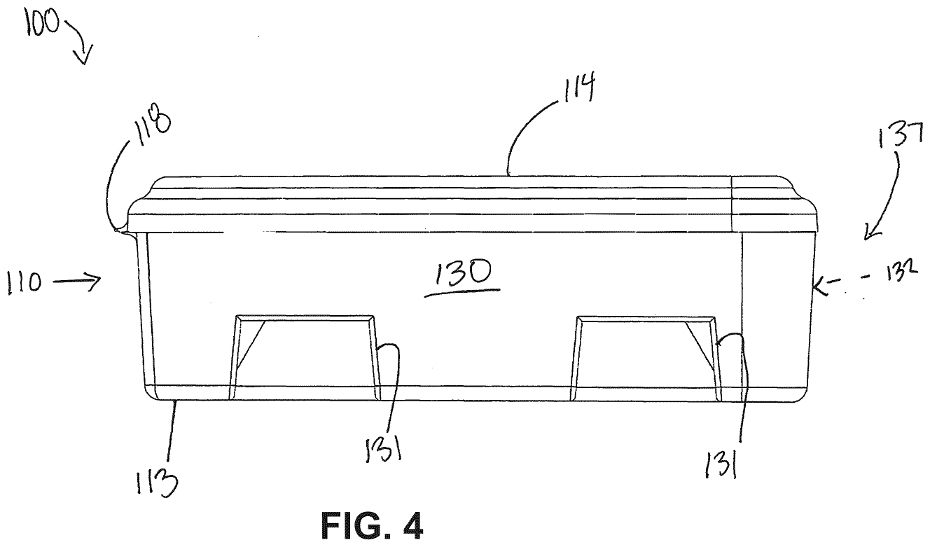

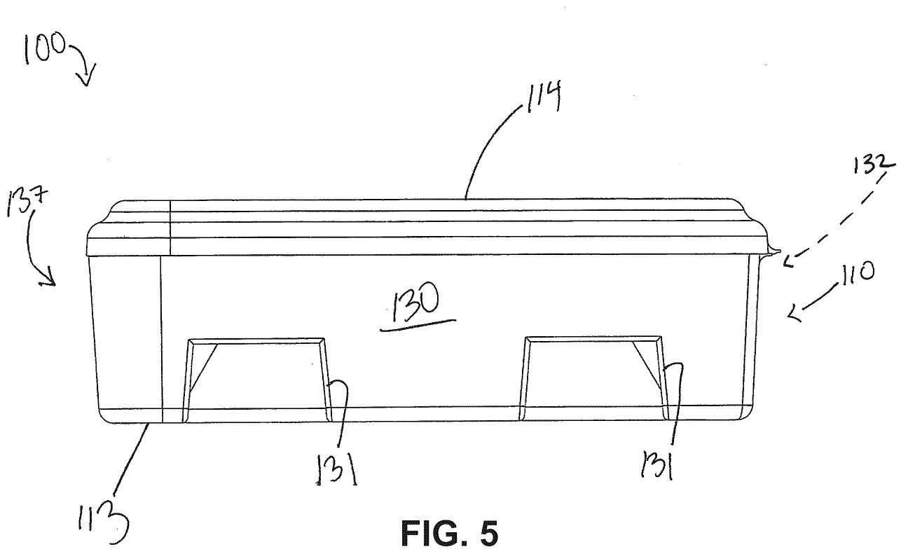

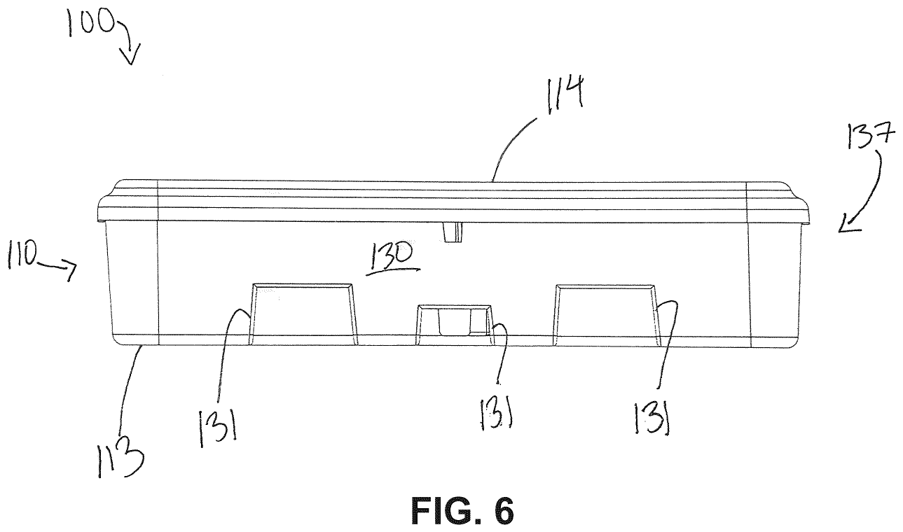

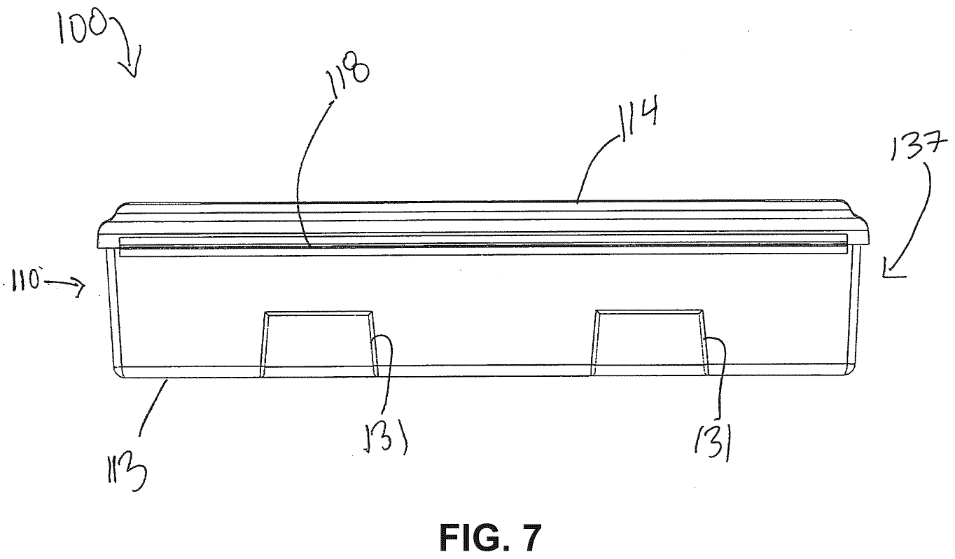

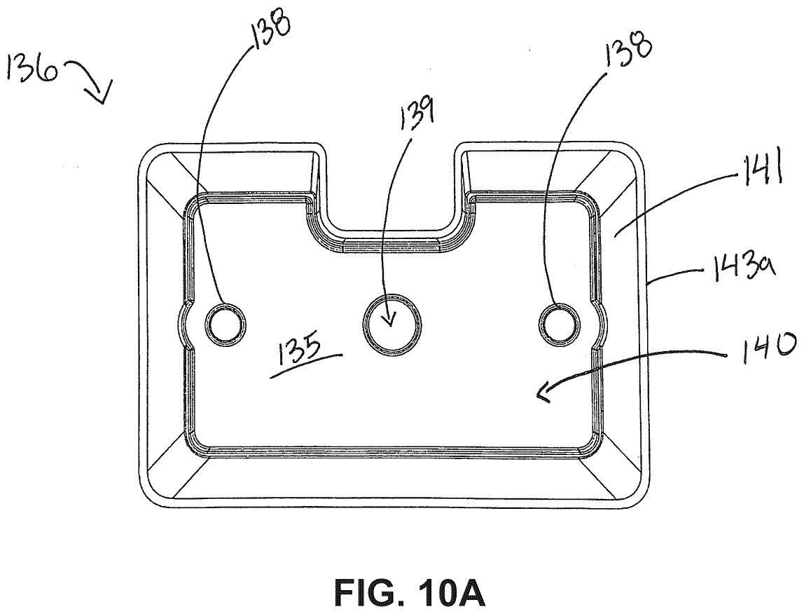

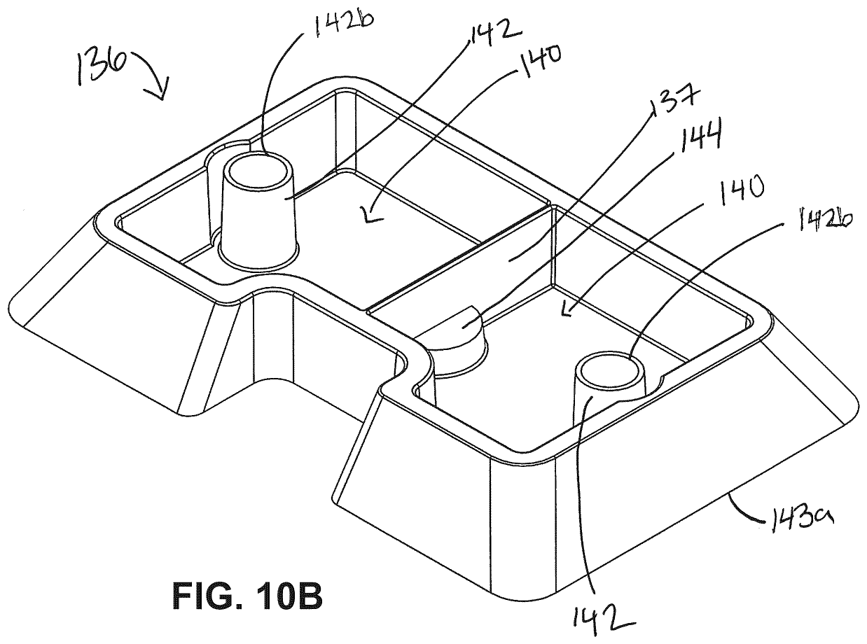

Referring now to the drawings, shown therein and designated by the reference numeral 100 is a first embodiment of the present pest management apparatuses. As reflected in FIGS. 1-10B, apparatus 100 comprises base 110 and lid 114 that is coupled to base 110. Lid 114 is coupled to base 110 with hinge 118, which is a living hinge that extends along substantially the length of the base and/or the lid, such that lid 114 is movable relative to base 110 between closed and open positions (see, e.g., FIGS. 1-2). In other embodiments (not shown), the lid and base may be coupled with a hinge having multiple hinge portions, such as multiple living hinge portions or multiple hinge portions that couple together through a snap-fit or the like. Base 110 comprises floor 126 and sidewall 130, which defines an external perimeter of base 110. Sidewall 130 is preferably molded from a suitable plastic material as an integral unit. In the closed position, base 110 and lid 114 cooperate to define chamber 132 (see, e.g., FIG. 1).

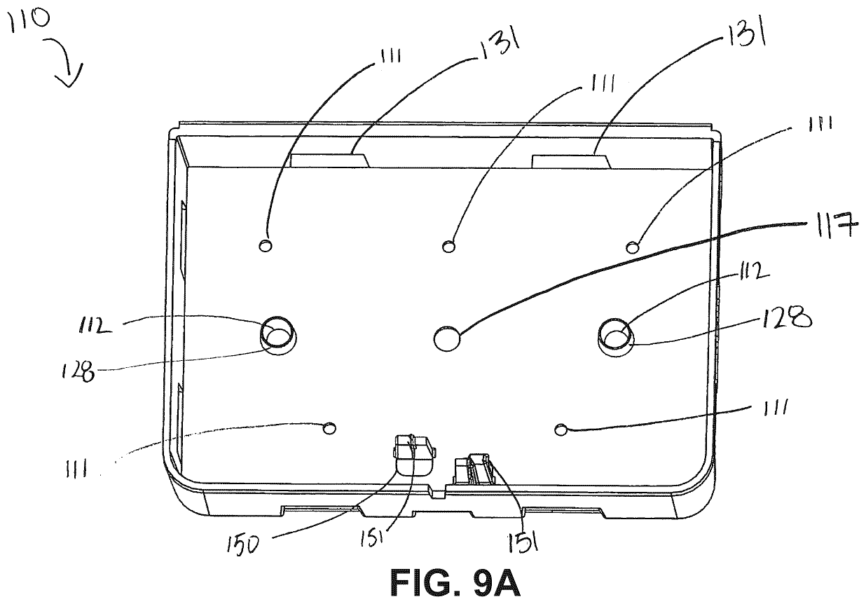

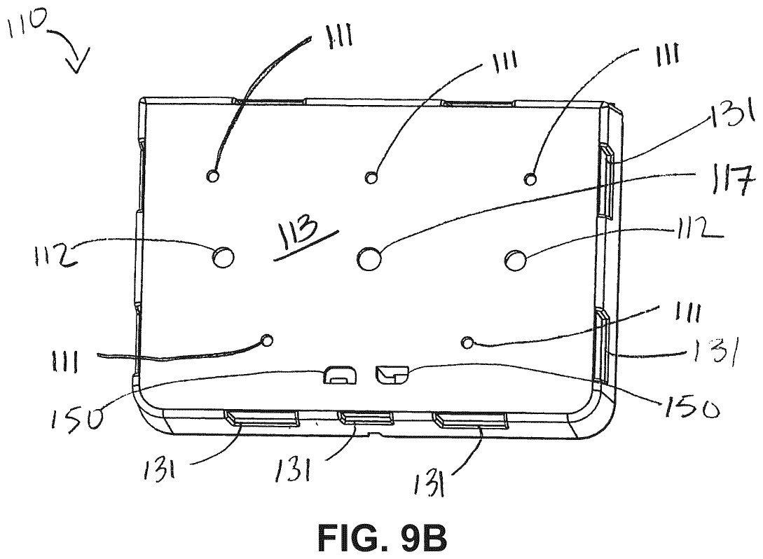

As shown, for example, in FIG. 9B, base 110 (and, more specifically, floor 126 of base 110) comprises one or more openings 112, which extend through the bottom surface 113 of the base. Floor 126 comprises one or more hollow protrusions 128, each beginning at a location of an opening 112 and extending vertically into chamber 132 (e.g., apparatus 100 includes two such protrusions). Each hollow protrusions 128 is open at its upper and lower portions, as FIG. 9A shows. Sidewall 130 comprises one or more openings 131 (e.g., apparatus 100 includes seven such openings). Base 110 (and, more specifically, floor 126 of base 110) comprises one or more openings 111, which extend through the bottom surface 113 (see, e.g., FIGS. 9A and 9B).

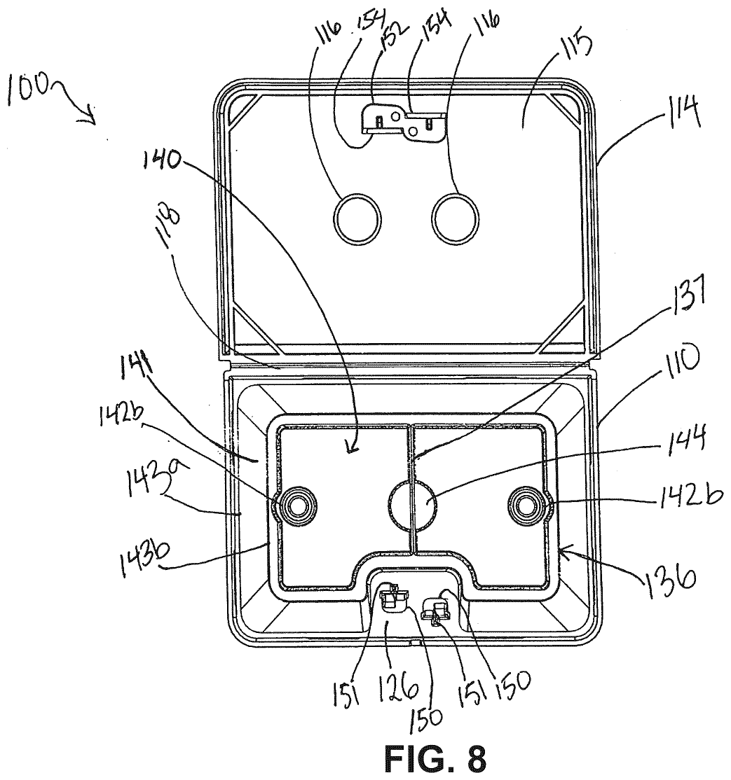

Apparatus 100 comprises inner tray 136 disposed within chamber 132. Inner tray 136 comprises first recessed portion 140 and ramp 141 that projects outwardly from and surrounds first recessed portion 140 (see, e.g., FIGS. 2 and 8). A bait (not depicted) can be housed in first recessed portion 140. First recessed portion 140 comprises one or more hollow protrusions 142 that extend vertically toward lid 114, with the lower opening 138 of each protrusion located in bottom surface 135 of inner tray 136 and the upper opening 142b located at the top portion of each hollow protrusion 142.

Hollow protrusions 128 of base 110 extend into the one or more (e.g., circular) openings 138 of inner tray 136 such that hollow protrusions 128 extend into hollow protrusions 142 of the inner tray. As shown, for example, in FIG. 2, a portion of base 110 is nested within a portion of inner tray 136, which may couple or, in some embodiments, affix inner tray 136 to base 110 though a friction fit, such that insects may crawl into the inner chamber to access bait through openings in the floor of the base without being exposed outside the outer perimeter of the apparatus.

Inner surface 115 of lid 114 comprises one or more hollow protrusions 116 (e.g., apparatus 100 includes two such protrusions) that extend vertically into first recessed portion 140 when lid 114 is in the closed position such that at least a portion of hollow protrusions 116 fit over hollow protrusions 142.

As shown, for example, in FIGS. 2 and 8, inner tray 136 comprises one or more walls 137 (e.g., apparatus 100 includes one such wall) within first recessed portion 140, dividing first recessed portion 140 into two more compartment (e.g., apparatus 110 includes two such compartments).

Ramp 141 of inner tray 136 has an external perimeter that is larger at its lower portion 143a than at its upper portion 143b. This ramped surface leads insects entering through openings 131 into recessed portion 140.

As shown in FIGS. 8-9B, floor 126 of base 110 comprises one or more lock openings 150 and one or more floor tooth projections 151, which extend upwardly from a surface of floor 126. As shown in FIGS. 1, 2, and 8, lid 114 one includes or more lid tooth projections 152, which extend downwardly from a surface of lid 114, and one or more lock openings 154. When the lid is in the closed position, one or more of the one or more lid tooth projections 152 fit into and contact one or more of the one or more lock openings 150 and one or more of the one or more floor tooth projections 151 fit into and contact one or more of the one or more lid openings 154 of lid 114 such that the lid 114 and base 110 resist separation in response to being pulled in opposite directions.

Inner tray 136's bottom surface 135 includes a second recessed portion 139. First recessed portion 140 includes a protrusion 144 that corresponds to second recessed portion 139. Base 110 includes an (e.g., circular) opening 117 that aligns with the second recessed portion 139.

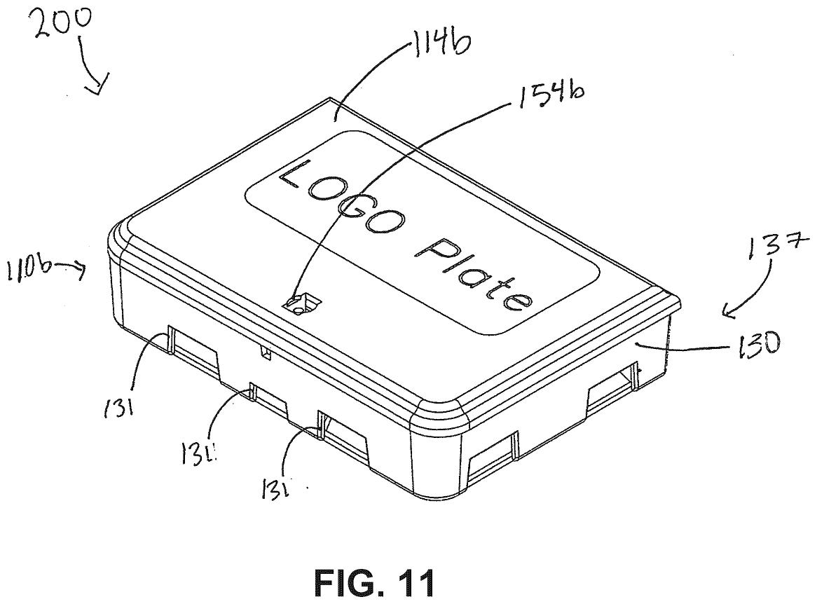

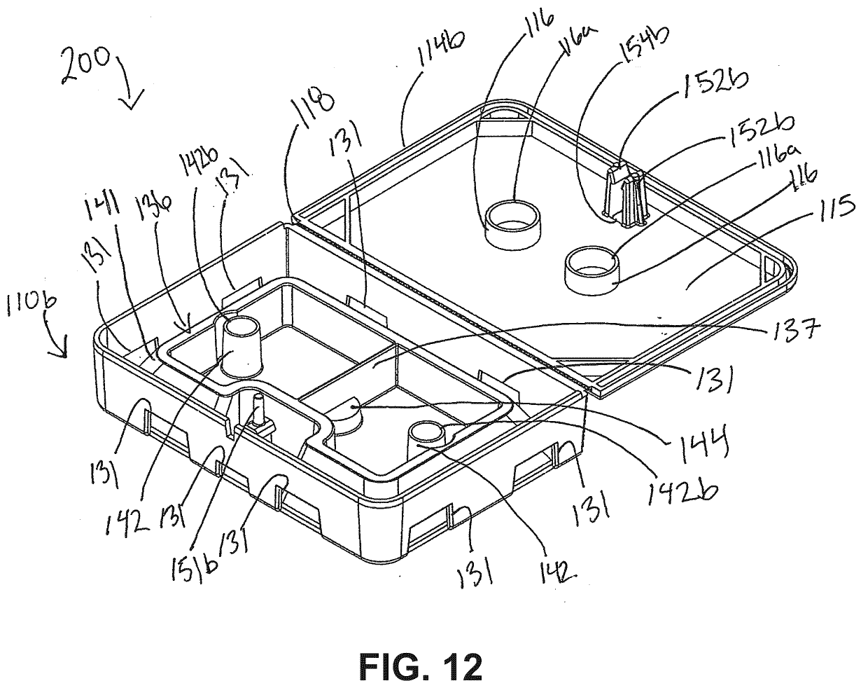

Referring to FIGS. 11-12, shown is pest management apparatus 200, another embodiment of the present pest management apparatuses and that is substantially similar to apparatus 100 except for the configuration of lid 114b, the shape of the one or more lid openings 154b and one or more lid tooth projections 152b, and the configuration of base 110b and the shape of one or more floor tooth projections 151b (only one of which is part of base 110b of apparatus 200; additionally, base 110b does not include one or more lock openings).

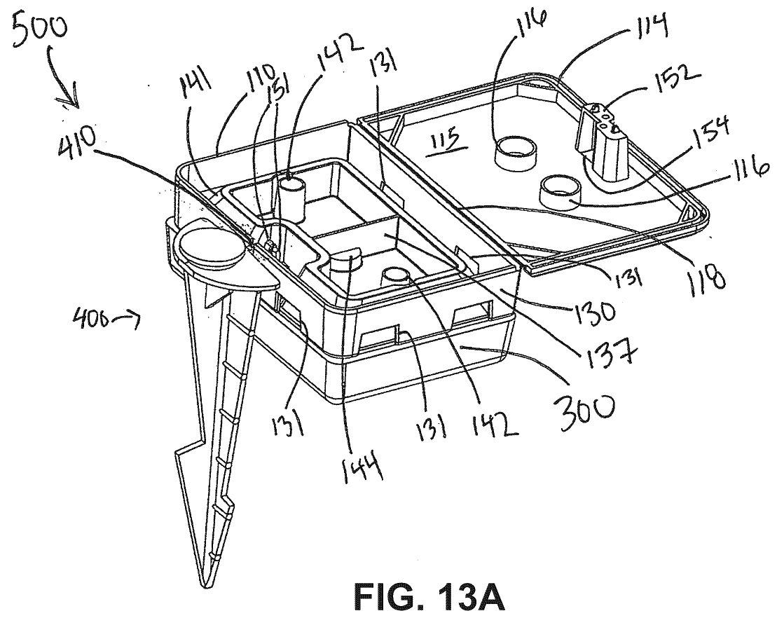

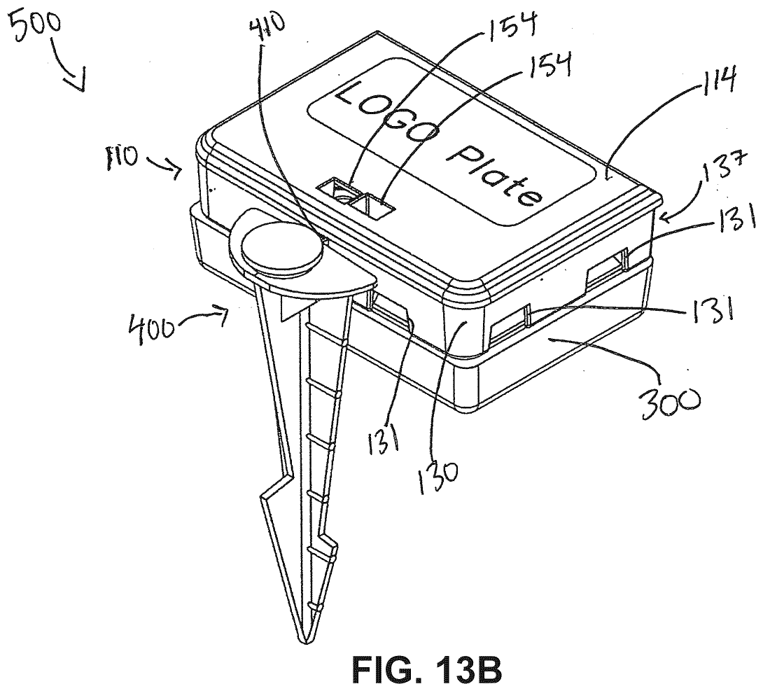

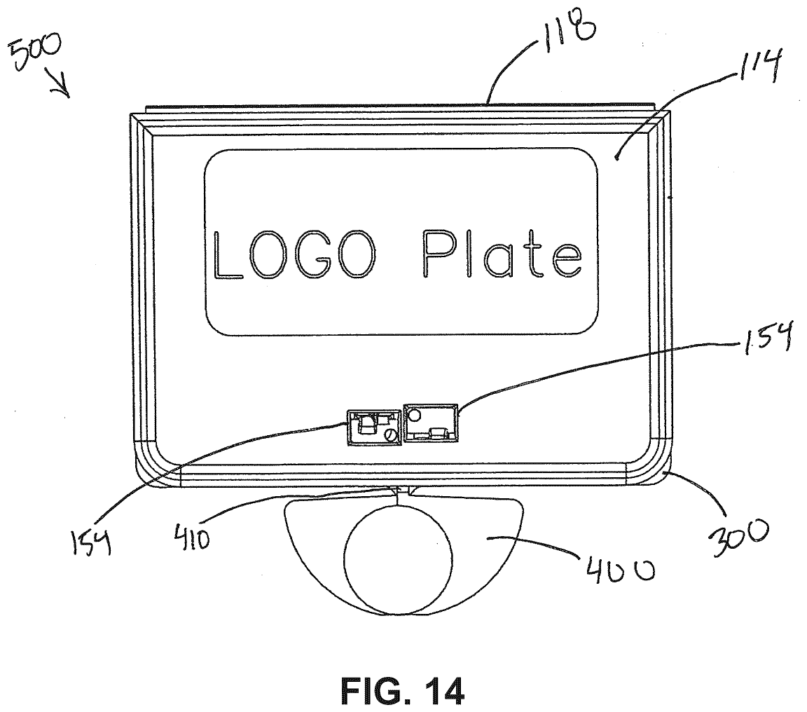

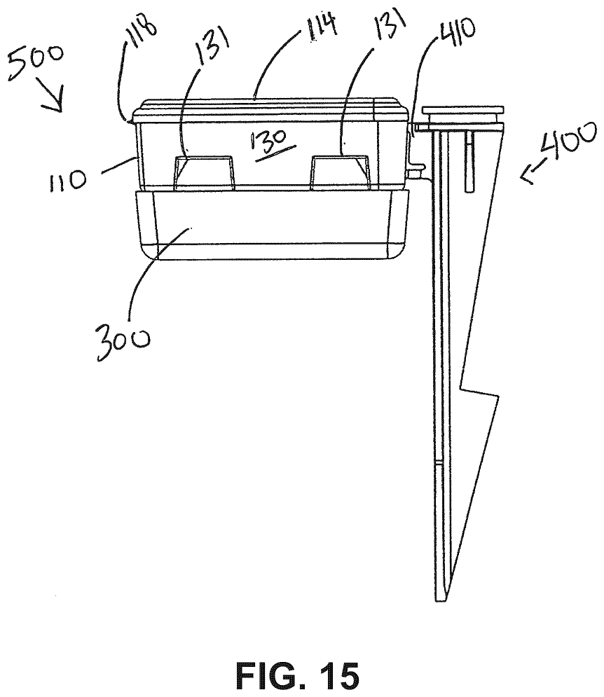

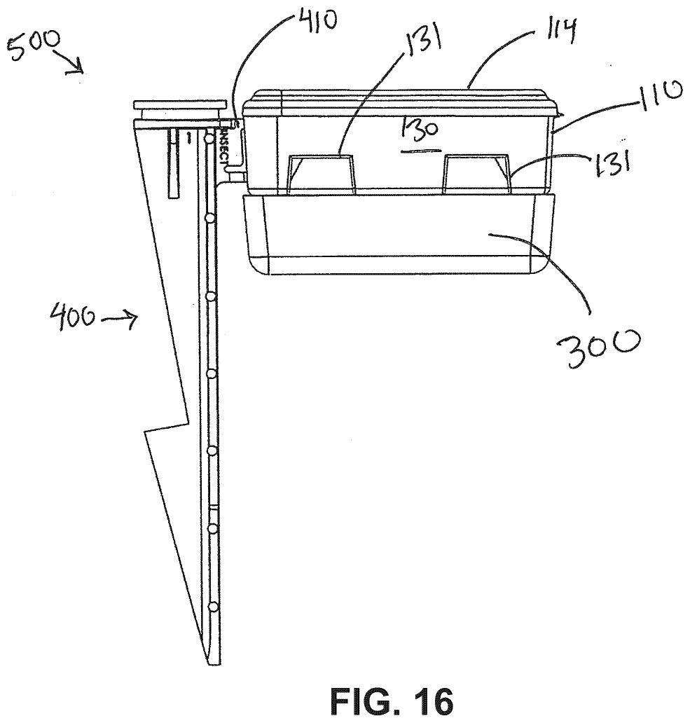

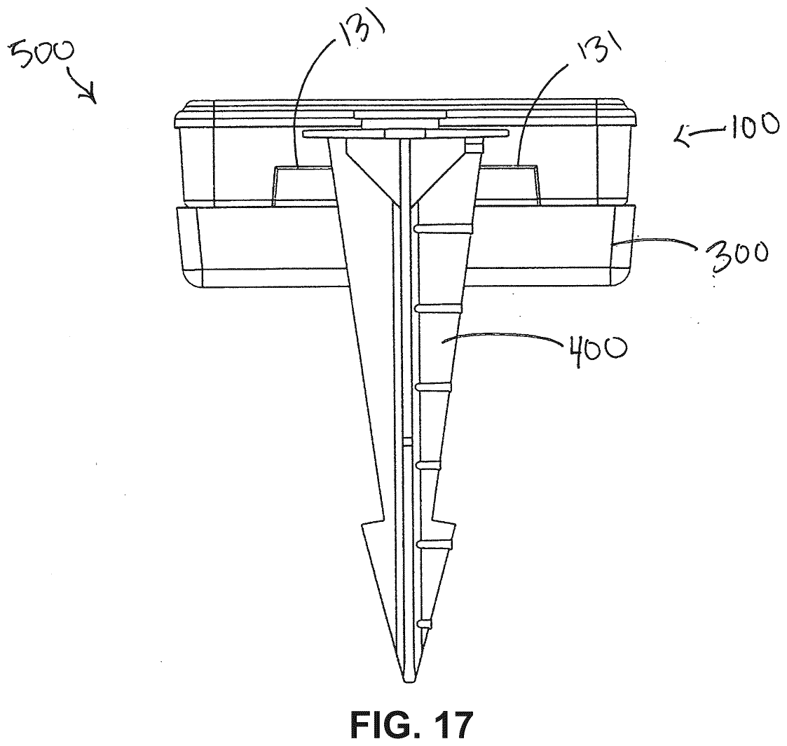

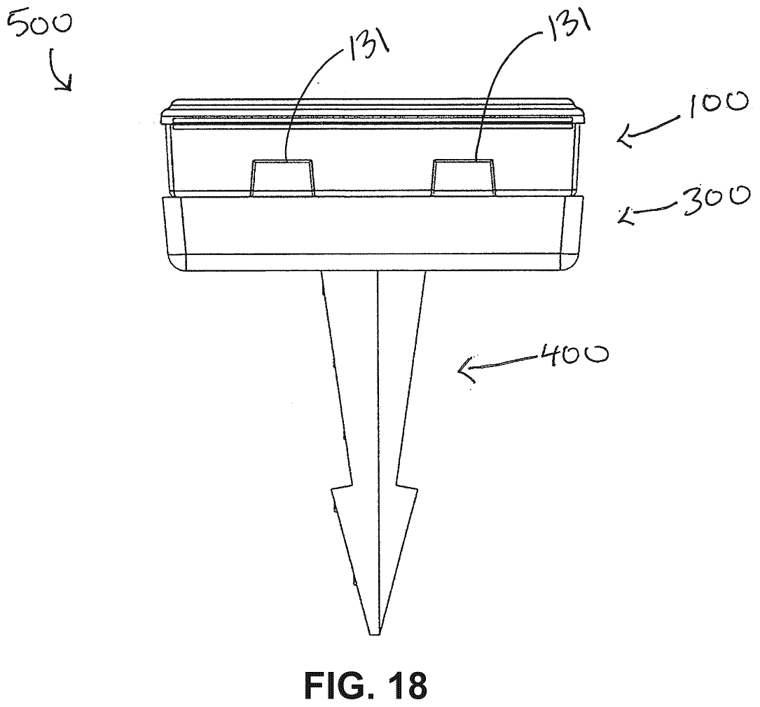

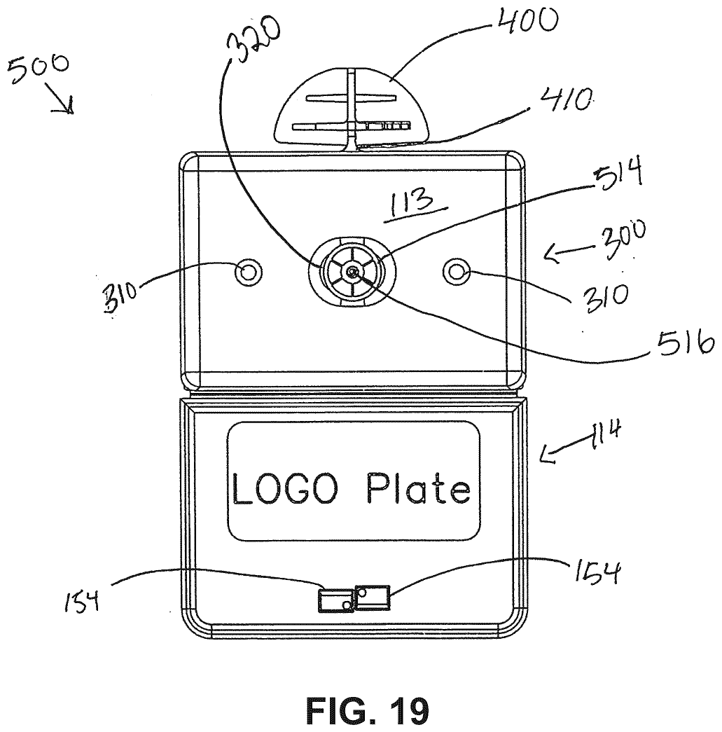

Referring to FIGS. 13A-19, shown therein and designated by reference numeral 500 is another embodiment of the present pest management apparatuses.

Apparatus 500 includes apparatus 100 fixed to anchoring base 300 in any suitable manner, such as a by a fastener 516 that couples base 110 to frusto-conical attachment piece 514 (such as the frusto-conical attachment piece in U.S. Pat. No. 8,874,098) that is in contact with anchoring base 300. In other configurations, attachment piece 514 may have any suitable shape and may, for example, include a nut, a clip, or any other structure configured to interact fastener 516 to resist separation of apparatus 100 from base 300. Anchoring base 300 provides apparatus 100 with additional stability compared to an implementation of apparatus 100 alone. Apparatus 100 is typically formed from plastic (through, for example, injection molding techniques), but may alternately be fabricated from other materials or combinations of materials. Anchoring base 300 may be formed of a polymer, or any other suitable material, and be significantly heavier than apparatus 100.

Some embodiments of anchoring base 300 and bait station 100 may have substantially the same shape (see, e.g., FIG. 13A). Anchoring base 300 includes openings 310 that correspond to openings 112 of bottom surface 113 of base 110. Anchoring base 300 also includes opening 320 aligned with opening 117 of base 110 such that fastener 516 may fit through opening 117 and opening 320 to fix base 110 to anchoring base 300 by coupling to attachment piece 514.

Apparatus 500 includes stake 400 coupled to base 110 and designed to enhance the stability and effectiveness of the trap, particularly in outdoor settings. Stake 400 can consist of any durable material, such as metal, and is securely attached to the base through a tab 410 that fits into one opening 131 of sidewall 130. Although stake 400 may be used in conjunction with anchoring base 300 (see e.g., FIGS. 13A-19), typically one or the other will be used.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the apparatuses and methods are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one embodiment or may relate to several embodiments.

The claims are not intended to include, and should not be interpreted to include, means-plus-or step-plus-function limitations, unless such a limitation is explicitly recited in a given claim using the phrase(s) “means for” or “step for,” respectively.

1. A pest management apparatus comprising:
a base having a floor defining one or more openings, each extending through the floor;
a lid coupled to the base such that the lid and the base cooperate to form a chamber when the lid is in a closed position; and
an inner tray comprising one or more openings, the inner tray configured to be disposed within the chamber with at least one of the opening(s) of the inner tray at least partially aligned with at least one of the opening(s) of the floor such that the chamber is accessible by a pest through the respective aligned openings of the floor and the inner tray.

2. The apparatus of claim 1, wherein the base comprises a sidewall that defines an external perimeter of the base.

3. The apparatus of claim 2, wherein the sidewall comprises one or more openings.

4. The apparatus of claim 1, wherein the floor of the base further comprises one or more protrusions, each protrusion extending from the floor into the chamber beginning near one of the one or more openings of the floor, and each protrusion having a passageway in communication with one of the one or more openings of the floor and the chamber.

5. The apparatus of claim 1, wherein the inner tray comprises a first recessed portion and a ramp that projects outwardly from and surrounds the first recessed portion.

6. The apparatus of claim 1, wherein at least a portion of each protrusion of the base extends into one of the opening(s) of the inner tray.

7. The apparatus of claim 1, wherein at least a portion of each protrusion of the base is within a protrusion of the inner tray such that at least a portion of the base is nested within a portion of the inner tray.

8. The apparatus of claim 1, wherein the first recessed portion of the inner tray is in fluid communication with space external to the bottom surface of the base.

9. The apparatus of claim 1, wherein an inner surface of the lid comprises one or more protrusions that extend toward the first recessed portion of the inner tray when the lid is in the closed position.

10. The apparatus of claim 9, wherein the external perimeter of the ramp is larger at a lower portion of the inner tray than at an upper portion of the inner tray.

11. The apparatus of claim 1, wherein the lower portion of the inner tray comprises a second recessed portion.

12. The apparatus of claim 11, wherein the first recessed portion of the inner tray comprises a protrusion corresponding to the second recessed portion.

13. The apparatus of claim 12, wherein the floor of the base defines an opening that aligns with the second recess of the inner tray.

14. The apparatus of claim 9, wherein the first recessed portion of the inner tray is divided into two or more compartments.

15. The apparatus of claim 1, wherein the apparatus further comprises an anchoring base coupled to the base such that a portion of the anchoring base is in contact with a portion of the base.

16. The apparatus of claim 15, wherein the anchoring base comprises one or more opening(s), and wherein at least one of the opening(s) of the anchoring base is at least partially aligned with at least one of the opening(s) of the floor such that the chamber is accessible by a pest through the respective aligned openings of the anchoring base, the floor, and the inner tray.

17. The apparatus of claim 1, wherein the lid comprises one or more openings and one or more lid tooth projections such that the one or more lid tooth projections are disposed within the chamber when the lid is in the closed position.

18. The apparatus of claim 1, wherein the floor of the base comprises one or more lock openings and one or more floor tooth projections, and wherein, when the lid is in the closed position, the one or more lid tooth projections fit into the one or more lock openings of the of the floor of the base and the one or more floor tooth projections fit into the one or more openings of the lid such that the lid and the base resist separation in response to being pulled in opposite directions.

19. The apparatus of claim 1, further comprising a stake coupled to the base.

20. The apparatus of claim 1, wherein a at least a portion of the base is nested within at least a portion of the inner tray.
